(19) United States
(12) Patent Application Publication
(10) Pub. No.: US 2017/0142203 A1
(43) Pub. Date: May 18, 2017

(54) METHOD FOR HOST SCHEDULING FOR CONTAINER DEPLOYMENT, ELECTRONIC DEVICE AND NON-TRANSITORY COMPUTER-READABLE STORAGE MEDIUM

(71) Applicants: LE HOLDINGS (BEIJING) CO., LTD., Beijing (CN); LECLOUD COMPUTING CO., LTD., Beijing (CN)

(72) Inventor: Jie Zhang, Beijing (CN)

(21) Appl. No.: 15/248,557

(22) Filed: Aug. 26, 2016

Related U.S. Application Data
(63) Continuation of application No. PCT/CN2016/082827, filed on May 20, 2016.

(30) Foreign Application Priority Data
Nov. 17, 2015 (CN) 201510790410.5

(51) Int. Cl. H04L 29/08; H04L 12/24

(52) U.S. Cl. CPC H04L 67/1097; H04L 41/0803

(57) ABSTRACT

Disclosed is a method for host scheduling for container deployment and an electronic device. The method includes: obtaining configuration information and corresponding host cluster of the container to be deployed; obtaining a list of online hosts in the host cluster, and generating a list of deployable hosts according to the configuration information and resource information of hosts in the list of online hosts. The container may be deployed on a suitable host appropriately to achieve a full and balanced utilization of the host resources.

### CROSS REFERENCE TO RELATED APPLICATIONS

This application is a continuation of International Application No. PCT/CN2016/082827, filed on May 20, 2016, which is based upon and claims priority to Chinese Patent Application No. 201510790410.5, filed on Nov. 17, 2015, the entire contents of which are incorporated herein by reference.

### TECHNICAL FIELD

The disclosure relates to the technical field of a container deployment and, in particular, to a method for host scheduling for container deployment, an electronic device, and a non-transitory computer-readable storage medium.

### BACKGROUND

Docker is an open source application container engine that allows developers to package their applications as well as dependent packages to a portable container, and then publish it to any of the popular Linux machines, which can also be virtualized. The containers fully utilizing a sandbox mechanism do not have any interfaces between each other, have almost no performance overhead, and can easily run in a machine and the data center. Most important, they do not depend on any languages, frameworks, including the system.

With the promotion for Docker technology in cloud computing, more and more application services began to deploy in the container. Since there is a difference in the configuration of hosts at which applications services locate, as well as in memory, CPU, hard disk, and network environment, how to deploy the container to an appropriate host to meet various container deployment demands based on a certain deployment strategy is an urgent problem to be addressed in the industry.

### SUMMARY

The present application provides a host scheduling method for the container deployment, an electronic device, and a non-transitory computer-readable storage medium to solve the problem that the container cannot be deployed appropriately on a suitable host, so as to achieve full and balanced utilization of the host resources.

According to an aspect of embodiments of the present application, a method is provided to host scheduling for container deployment including: obtaining configuration information of the container to be deployed and a corresponding host cluster; obtaining a list of online hosts in the host cluster, and generating a list of deployable hosts according to the configuration information and resource information of hosts in the list of hosts.

According to another aspect of embodiments of the present application, there is further provided a non-transitory computer-readable storage medium storing executable instructions used to execute any one of methods of the present application as described above.

According to yet another aspect of the embodiments of the present application, there is further provided an electronic device that includes at least one processor and a memory for storing instructions executable by the at least one processor, wherein execution of the instructions by the at least one processor causes the at least one processor to execute any one of methods of the present application as described above.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart illustrating a method for host scheduling for container deployment according to an embodiment of the present application;

FIG. 2 is a flowchart illustrating an embodiment of a method for generating a list of deployable hosts in the method shown in FIG. 1;

FIG. 3 is a flowchart illustrating another embodiment of a method for generating a list of deployable hosts in the method shown in FIG. 1;

FIG. 4 is a schematic diagram illustrating a host scheduling system for container deployment according to an embodiment of the present application;

FIG. 5 is a diagram showing an architecture for implementing an embodiment of a method for host scheduling and a system for container deployment of the present application; and

FIG. 6 is a schematic diagram showing a structure of an electronic device for implementing a method for host scheduling for container deployment according to an embodiment of the present application.

### DETAILED DESCRIPTION

In order to make the purpose, technical solutions, and advantages of the embodiments of the present application more clear, the embodiments described herein are done so by providing the technical solutions in the embodiment of the present application clearly and completely in conjunction with the figures in the embodiment of the present application. The described embodiments therefore may not include all possible embodiments. Based on the description provided herein, other embodiments obtained by those of ordinary skill in the art without creative efforts are within the scope of the present application.

A container includes properties of a port mapping (i.e., exports attribute), a directory mapping (i.e., volume attribute) and a maximum memory (i.e., mem attribute). The port mapping refers to a specific port of the container and a port of the host can be specified to establish a mapping when the container is created. For example, a mapping is set between port 22 of the container and port 2222 of the host, and port 22 of the container can be indirectly accessed by accessing 2222 port of the host after the mapping. If no host port is specified, a mapping is set between a port randomly assigned by the Docker and the port of the container at the startup of the container. Since a port can only be open to a service, assuming that a container has set a mapping between port 22 and a port 2222 of the host, and the container has been started up, then, if another container also set a mapping between port 22 and a port 2222 of this host as the mapping, the container cannot be started up because the port 2222 is already occupied.

Directory mapping means allowing a directory of the container and a directory of the host as the mapping, and meanwhile specifying whether the directory of the mapping is writable. For example, setting a mapping between /srv directory of the container and /letv/srv directory of the host, and setting them to be writable, then writing file into /srv directory or reviewing the file in the interior of the container will be equivalent to the same operation in /letv/srv directory of the host. If mapping between /srv directory and /letv/srv directory of the host is also set together with a writability permission in a container of another transaction, then when the two containers of different services simultaneously operate the same directory, it is likely to lead to inconsistent data and cause data disorder, which is not allowable.

The maximum memory means that the container can be set the maximum memory, and maximum memory of the container means the maximum memory used by the process in the container. Once the maximum memory used by the process in the container exceeds the set maximum memory, the container will kill a specific process according to the priority. Therefore, when deploying the container, it is necessary to consider whether the memory of the host is sufficient for deploying the container. Therefore, these characteristics of the container will determine or affect whether the container can be deployed on a particular host.

Based on the relevant characteristics of the container, an embodiment of the present application provides a method for host scheduling for container deployment. The container deployment may be performed according to the memory to balance the memory load of the host. Meanwhile, the host scheduling may be performed according to the pre-stored container configuration information and the preset default host cluster resource information, which also facilitates services monitoring and log analysis.

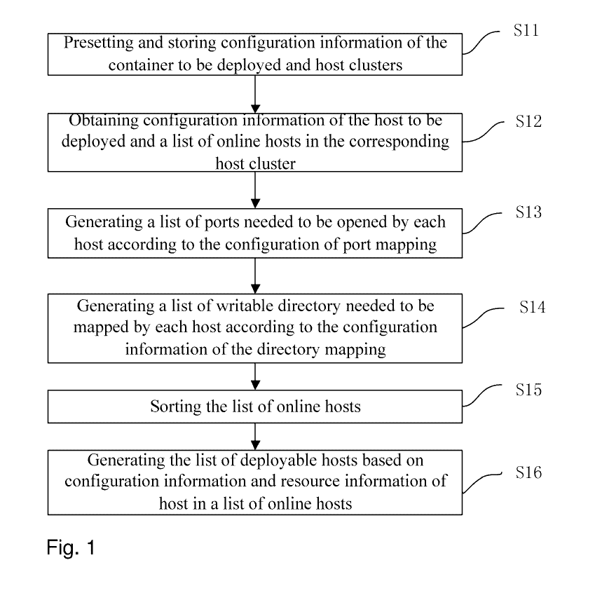

FIG. 1 is a flowchart illustrating a method for host scheduling for container deployment according to an embodiment of the present application. As shown in FIG. 1, the method includes the following steps.

Step S11: the dispatch center presets and stores configuration information of the container to be deployed and the host clusters.

According to the configuration information of the container to be deployed, a group of hosts having the same or similar configuration are set into a cluster. The containers are deployed in accordance with the host resources in the cluster to balance the host resources. Meanwhile, before the deployment, the container to be deployed, the container configuration information, the corresponding host cluster, and the host resource information in the host cluster are pre-stored into the database. Here, a group of hosts having same or similar configurations includes same or similar CPU, memory, hard disk, network, and machine room in which they located. Each host in the cluster corresponds to corresponding host resources, including remaining memory for container, a list of ports that have been already occupied, and a list of writable directory have been occupied. The remaining memory for the container is used to record the maximum memory amount allocated to the container.

Step S12: the dispatch center obtains configuration information of the host to be deployed and a list of online hosts in the corresponding host cluster.

Reading the current container to be deployed and its corresponding configuration information and host cluster from the database. The configuration information may be stored in the database in a json format including a directory mapping, a port mapping, a container memory, and the number of containers to be deployed. The container memory may be set to a value of mem, the number of containers to be deployed may be set to a value of Containernum, and the directory mapping information of the container may be defined in the following json format:

```
[
    {
        “host”:“/letv/srv”,
        “ro”:true,
        “container”:“/srv”
    }
]
```

It should be noted that a container can set multiple directory mappings, where “container” represents a directory of the container. “host” represents a directory of the host, and ro represents whether it is read-only permission. If “host” is set to “None,” it means the mapping directory of host is allocated by docker (the directory allocated by docker is set in accordance with directory prefix+uuid of the container, because uuid of the container is globally unique, it is not necessary to worry about the problem of duplicate directories).

Port mapping information is represented in the following json format:

```
[
    {
        “container”:22,
        “host”:2222
    }
]
```

It should be noted that multiple port mapping scan be set for a container, where the “container” field represents a port of the container, and the “host” field represents a port of the host. If the “host” field is set to “None,” it represents a random port generated by docker, and a port of the container may perform the mapping (the port assigned by docker will be allocated according to the situation of the existing ports, which will ensure the port not to be occupied).

The host cluster, to which the container to be deployed corresponds, includes a plurality of hosts. The hosts and resource information under the cluster are also saved in the database. After obtaining the host cluster, to which the container to be deployed corresponds, (for example, it may be the cluster name or ID form correspondingly stored in a database record of the container to be deployed), the list of online hosts in the host cluster may be obtained from the database (i.e., the host can provide service normally, including docker service running on the host is normal, the network is normal, etc.). For example, the list of online hosts may be obtained from the database such as [host1, host2, host3].

Step S13: the dispatch center generates a list of ports to be opened by each host according to the configuration of port mapping.

Depending on the read configuration information of port mapping, a specific port may be obtained that is mapped with the host set by the container to be deployed, and a port may be obtained to be opened by each host, which is added to the list of ports to be opened by the host. The list of ports may be set as a variable name of need_host_exports. For example, if the following exports (i.e., port) of mapping configuration information is read:

```
[
  {
    “container”:22,
    “host”:2222
  },
    {
    “container”:33,
    “host”:3333
  },
    {
    “container”:44,
    “host”:None
  }
]
```

The above host field in the configuration information may be read as follows. When the value of the host field is not None, a specific port number of each host needed to open for mapping with the container is obtained, and then added to the list of ports needed to open of each host with a variable name of need_host_exports, so as to obtain a list of ports needed to open as need_host_exports=[2222, 3333].

Step S14: the dispatch center generates a list of writable directory to be mapped by each host according to the configuration information of the directory mapping.

According to the read configuration information of directory mapping, a writable directory mapped with the host set by the container to be deployed is obtained, so as to obtain a writable directory to be mapped by each host, and is added to the list of writable directory to be mapped by the host. The list of writable directories is set as a variable name of need_host_volumes. For example, if the following volumes (i.e., directory) mapping configuration information is read:

```
[
  {
    “host”:”/letv/data”,
    “ro”:false,
    “container”:”/data”
  },
    {
    “host”:”/letv/data”,
    “ro”:true,
    “container”:”/srv”
  },
    {
    “host”:None,
    “ro”:true,
    “container”:”/test”
  }
]
```

The above host field in the configuration information may be read so that further operations can be carried out as follows. When the value of the “host” field is not “None,” the “ro” field may be read. When the value of “ro” is false simultaneously, a writable directory may be mapped by each host, and a corresponding container is obtained and added to the list of writable directory to be mapped by each host with a variable name of need_host_volumes, so as to obtain a list of writable directory to be mapped, need_host_volumes=[“/letv/data”].

Step S15: the dispatch center sorts the list of online hosts.

The obtained list of available online hosts such as [host1, host2, host3] is sorted in accordance with resource information of each host, preferably, in accordance with a descending order of the remaining memory, to obtain a new sorted list of online hosts, for example[host3, host2, host1]. As such, when traversing the list of online host to perform selection of the host capable to be deployed by the container to be deployed, it can be ensured that the host is preferably used with maximum remaining memory for container to perform deployment. That is, the maximum remaining memory for container, e.g., host 1, is preferably read to match host resources.

Step S16: the dispatch center generates the list of deployable hosts based on the configuration information and resource information of a host in a list of online hosts.

If the obtained number of containers to be deployed is smaller than the number of containers to be deployed, then a host is obtained in turn from a sorted list of online hosts. The remaining memory for the container of a host may be obtained from the list of online hosts, the list of occupied ports, the list of occupied writable directory, and the container memory mem obtained from the configuration information. The list of ports to be opened by each host need_host_exports and the list of writable directory to be mapped by each host need_host_volumes may be matched respectively with the remaining memory for container of a host obtained from the list of online hosts, the list of occupied ports, and the list of occupied writable directory.

According to the judgment result of the match, if current available resources of the host meet the conditions that the remaining memory for container is larger than the container memory, the list of occupied ports does not contain any port which is the same as that in the list of ports to be opened by each host, and there is not a mutual contained directory in the list of the writable directory occupied and the list of the writable directory to be mapped by each host, then the current host meeting the above conditions is added into the list of the hosts that can deploy the container. Otherwise, the current hosts not meeting these conditions are deleted from the list of online hosts. The above operations are repeated until the number of hosts in the list of the deployable hosts equals the number of containers to be deployed to obtain the list of deployable hosts.

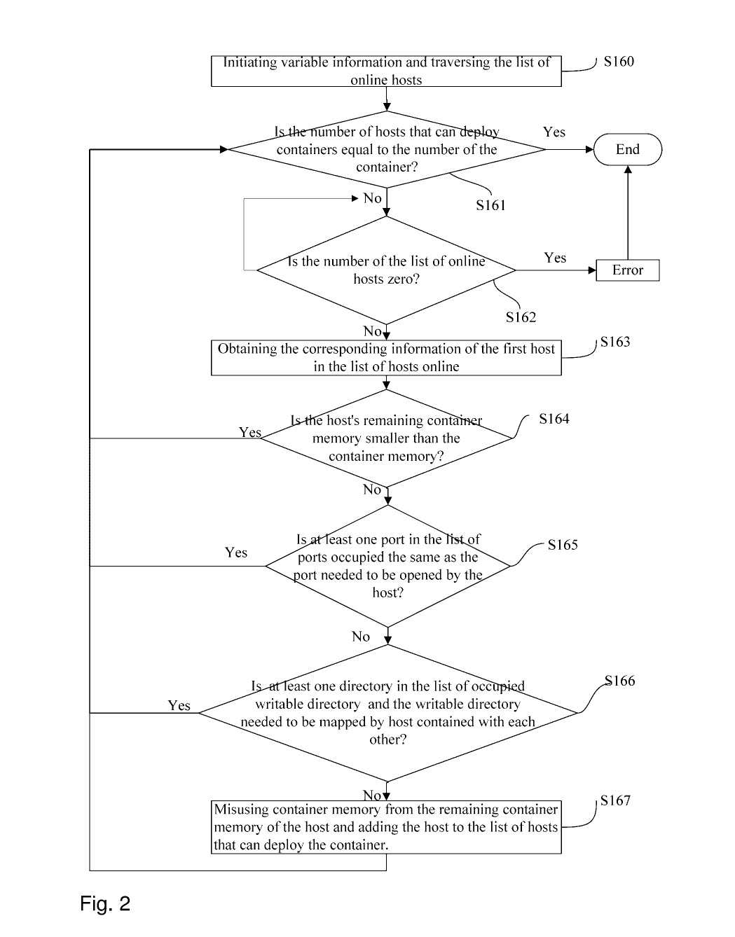

FIG. 2 is a flowchart illustrating an embodiment of a method for generating a list of deployable hosts in the method shown in FIG. 1. The method of the present application includes:

Step S160: the dispatch center initializes variable information and traverses the list of online hosts.

A “compute” variable is set and initialized to be an empty list for recording the calculated host that can deploy containers. A deploy_container_num variable is set and initialized to 0 for recording the number of hosts that can deploy containers (i.e., the number of hosts meeting deployment conditions), and the value of the variable is the length of the list of deployable hosts “compute.” After variable initialization is completed, traversing of the sorted list of online hosts is repeated to assess the available hosts in the cluster based on the memory size, to determine whether the current container is suitable for deployment.

Step S161: the dispatch center may determine whether the number of hosts that can deploy containers is equal to the number of containers.

At the beginning of each loop, a number of the list of hosts that can deploy the container is first obtained. That is, the value of deploy_container_num may be compared with the number of containers to be deployed (i.e., the obtained Containernum value), thereby determining whether deploy_container_num equals to Containernum. If so, it means that the number of the hosts in the list of hosts that can deploy containers has reached the number of containers to be deployed, and the process for choosing a proper host for the container to be deployed in the cluster has been completed. A jump may then be done from the loop to end the operation, and the list of hosts that can deploy container “compute” is output. If not equal, the process may proceeds to step S162.

Step S162: the dispatch center determines whether the number of the list of online hosts is zero.

The length of the list of online hosts may be obtained to determine whether it is 0. If it is 0, since the number of the list of hosts that can deploy container deploy_container_num obtained from step S161 is not equal to the number of containers to be deployed Containernum, then it means the host in the currently host cluster does not have sufficient resources to deploy containers in a number of Containernum. Therefore, an error occurs (e.g., outputting exception or error message) and a jumping out of the loop is done. If it is not 0, then the process goes to step S163.

Step S163: the dispatch center obtains the corresponding information of the first host in the list of hosts online.

In accordance with the order of reading the list, the host which is in the most head-end position in the current list (i.e., the first host in the list), such as host1, for example) is obtained from the list of online hosts and the remaining memory for the container to which the host corresponds, the list of ports occupied, and the list of writable directory occupied are read from the database to be processed in step S164. Since the list of online hosts is a list sorted according to the remaining memory for container in a descending order, the obtained first host in the head-end position is the host with the maximum remaining memory for container, which ensures the container to be deployed preferentially on the host with the maximum remaining memory for container to better use the existing resources and to maximize the use of resources.

Step S164: the dispatch center determines whether the host's remaining memory for container is smaller than the container memory.

The host's remaining memory for container is compared with the memory of the container to be deployed (i.e., the value of mem) to determine whether the remaining memory for container is smaller than the container memory. If so, it means that the host does not have enough memory resources to deploy according to the needs of the current container, and then the host (e.g., host1) is deleted from the list of online hosts, and the process jumps to step S161 to make a determination in the next loop. If not, the process proceeds to step S165. Thus, it is possible to prevent total memory of the containers on each host from exceeding the maximum amount of memory of the host, which may cause overload of the host. Furthermore, the problem that the container kills a specific process due to insufficient memory can be avoided.

Step S165: the dispatch center determines whether at least one port in the list of ports occupied is same as the port to be opened by the host.

The ports in the list of ports occupied by host are sequentially compared with the ports in the list of ports to be opened by host need_host_exports to determine whether at least one port in the list of occupied ports is the same as the port to be opened by the host. If so, it indicates a specific port of the host is already occupied. If the container is currently deployed on the host, it will not start up properly due to port conflict, the host is then removed from the list of online hosts and the process jumps to step S161 to perform next round of processing (i.e., “judging”), so as to ensure the host for deployment supports the container and host port mapping settings. If the same port does not exist, the process proceeds to step S166.

Step S166: the dispatch center determines if there is at least one directory in the list of occupied writable directories of the host that constitutes a pair of mutual contained directories with a directory to be mapped by the host.

The directories in the list of occupied writable directories of the host are compared sequentially with the directories in the list of writable directories to be mapped by the host need_host_volumes to determine whether at least one directory in the list of occupied writable directories and the directory to be mapped by the host are contained each other (mutually contained). If such a pair of mutual contained directories exists, it means the specific directory of the host is already in use and the data can be written therein. If the container is deployed on the current host, there may be a data disorder due to simultaneously writing data into that specific directory. Therefore, the host is to be removed from the list of the online hosts and the process jumps to step S161 to do next determination, which ensures that the host for deployment supports the container and the host writable directory mapping setting. If there is no mutual contained directory, then the process proceeds to step S167.

The mutually contained relationship between any pair of directories means that the directory a is in the directory b, or the directory b is in the directory a. Taking</letv/data<” and “/letv,” for example, since the directory “/letv/data” is in the directory “/letv,” the two directories contain each other (or are mutually contained), thereby causing data disorder under that directory when performing data writing.

Step S167: The dispatch center subtracts container memory from the remaining memory for container of the host, and adds the host to the list of hosts that can deploy the container.

If the memory, ports, and directories of the current host all meet the requirements of container deployment, then the current host can deploy the container. At this time, the container memory mem is subtracted from the remaining memory for the container of the host at first, and the host is added to the list compute of hosts that can deploy the container. Furthermore, a value is reassigned to deploy_container_numed (which can be directly obtained a length of “compute” at the beginning of each loop, or automatically incremented by one every time in this step, which is not necessary to repeat since it can be realized by conventional techniques), and the process then jumps to step S161 for the next round of loop.

In the method as shown in FIG. 2, the dispatch center (the dispatch center is a server) can traverse and judge all hosts in the cluster of containers to be deployed to obtain a list of hosts that can deploy containers. The obtained host in the list of hosts that can deploy containers can support the mapping of the container and a specific port or writable directory of the host, and the container can avoid killing a process due to insufficient memory. Thus, the container can be deployed according to the needs of the container and the host configurations to maximize the use of basic resources and prevent conflicts of ports or of directories. Furthermore, by sorting hosts in the cluster according to memory thereof and performing container deployment according to the memory, it is possible to ensure that the container will be deployed on the host with the maximum remaining memory for the container that is preferable to achieve an equal distribution of memory resources in the host cluster.

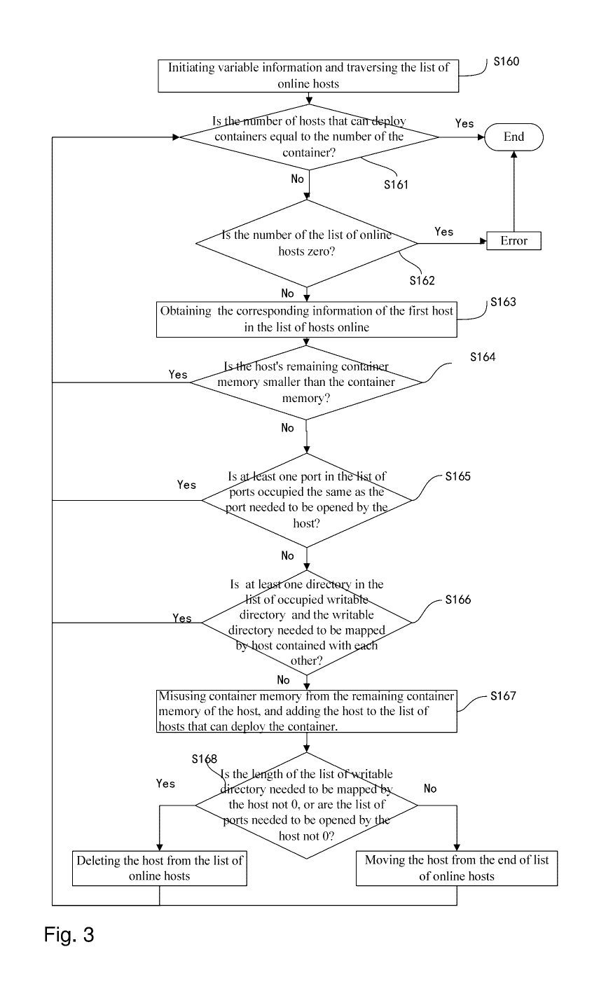

FIG. 3 is a flowchart illustrating another embodiment of a method for generating a list of deployable hosts in the method shown in FIG. 1. As shown in FIG. 3, the method of the present application embodiment is similar to that shown in FIG. 2, except that after step S167, the embodiment illustrated in FIG. 3 further includes:

Step S168: the dispatch center determines whether the length of the list of writable directory to be mapped by the host is not 0, or the list of ports to be opened by the host is not 0.

After adding a host which meets the conditions of the deployment, the length of the list need_host_volumes of writable directory to be mapped by the host and the length of the list need_host_exports of ports to be opened by the host are obtained. It is then determined whether one of the lengths is not zero. If either the length of need_host_exports or the length of need_host_volumes is not zero, then it indicates that the container sets a fixed host port or a writable directory, so next time the container of the same application will not be able to deploy on the host again because the corresponding port or writable directory of the host has already been occupied.

Therefore, if either length is not zero, the host currently meeting the deployment conditions that have been added into the list of deployable hosts is removed from the list of online hosts, and the process proceeds to the next loop from step S161. If both of the lengths are 0, it means that the current host as the potential for a further container deployment. The host currently meeting the deployment conditions is removed from the current position in the list of online hosts (e.g., the first host, namely the host in the first position that is subject to the judging in each round) to the end of the list of online hosts, and the process proceeds to the next loop from step S161. Thus, an equal allocation of containers can be guaranteed, thereby avoiding such situation as some hosts resources in the cluster are idle, while others experience overload.

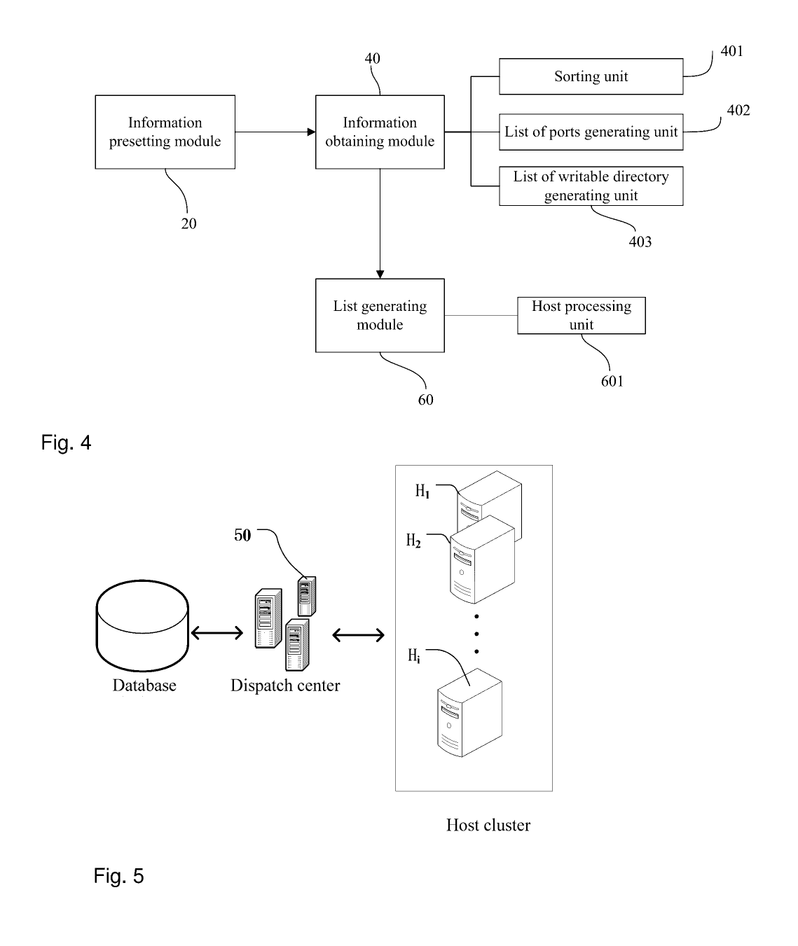

FIG. 4 is a schematic diagram illustrating a host scheduling system for container deployment according to an embodiment of the present application. As shown in FIG. 4, the container dispatch system of the embodiment of the present application includes an information presetting module 20, an information obtaining module 40, and a list generating module 60.

Information presetting module 20 may be configured to set the host cluster according to the information of container to be deployed, and store the configuration information of the containers to be deployed and the information of the corresponding host cluster. The configuration information may include the directory mapping information containers, port mapping information, container memory, and the number of containers to be deployed. The host cluster may set a group of hosts having the same or similar configuration to a host cluster according to the configuration requirements of the container to be deployed to deploy the container in this cluster. The host cluster may include multiple hosts having same or similar configuration, and the container to be deployed, the corresponding configuration information, and the corresponding host cluster may be stored by information presetting module 20 into a database. Hosts included in the host cluster and resource information of each host may also be stored in the database accordingly. Resource information of each host may include the remaining memory for the container of the host, the list of ports occupied, and the list of writable directory occupied.

Information obtaining module 40 may be configured to obtain the configuration information of the containers determined to be deployed by information presetting module 20 and the list of online hosts in the host cluster. During deployment of the container, the configuration information, and host cluster information to which the container to be deployed corresponds, may be obtained by information obtaining module 40 from the database, and the list of online hosts under the cluster may be read.

List generating module 60 may be configured to generate a list of the hosts that can deploy container according to the configuration information of the container and the resource information of the host in the list of online hosts determined by information obtaining module 40. List generating module 60 circularly traverses host information in the list of online hosts according to the number of the container determined to be deployed by information obtaining module 40 to judge the container memory and the remaining memory for the container, the directory mapping information, the list of writable directory occupied in the host, the port mapping information, and the matching status of the list of the ports occupied in the host, to generate a list of deployable hosts meeting the container configuration requirements.

The dispatch center in the host dispatch system for container deployment in the present embodiment may be implemented, for example, as a server or a server cluster, wherein each module may be a single server or server cluster. In this case, interactions among these modules are described as interactions among the servers or server clusters to which the modules correspond. The multiple servers or server clusters together may form a host dispatch system for the container deployment as described herein.

Specifically, a host dispatch system for deployment of container may be implemented as multiple servers or server clusters together according to the present application, and may include, for example, an information presetting server or server cluster 20, an information obtaining server or server cluster 40, and a list generating server or server cluster 60.

Information presetting server or server cluster 20 may be configured to set the host cluster according to the information of container to be deployed, and to store the configuration information of the containers to be deployed and the information of the corresponding host cluster. The configuration information may include the directory mapping information, port mapping information, container memory, and the number of container to be deployed. The host cluster may set a group of hosts having the same or similar configuration to a host cluster according to the configuration requirements of the container to be deployed, to deploy the container in this cluster. The host cluster may include multiple hosts having the same or a similar configuration, and the container to be deployed, the corresponding configuration information, and the corresponding host cluster, may be stored by the information presetting server or server cluster 20 into the database. Hosts included in the host cluster and resource information of each host may also be stored in the database accordingly. Resource information of each host may include the remaining memory for the container of the host, the list of ports occupied, and the list of writable directory occupied.

Information obtaining server or server cluster 40 may be is configured to obtain the configuration information of the container determined to be deployed by the information presetting server or server cluster 20 and the list of online hosts in the host cluster. During deployment of the container, the configuration information, and host cluster information to which the container to be deployed container corresponds, may be obtained by the information obtaining server or server cluster 40 from the database, and the list of online hosts under the cluster may be read.

List generating server or server cluster 60 may be configured to generate a list of the hosts that can deploy the container according to the configuration information of the container and the resource information of the host in the list of online hosts determined by the information obtaining server or server cluster 40. List generating server or server cluster 60 circularly traverses host information in the list of online hosts according to the number of the containers determined to be deployed by the information obtaining server or server cluster 40 to judge the container memory and the remaining memory for container, the directory mapping information, the list of writable directory occupied in the host, and the status of the matching between the port mapping information and the list of the ports being occupied in the host, to generate a list of deployable hosts meeting the container configuration requirements.

In an alternative embodiment, several modules in the above plurality of modules may together constitute a server or server cluster. For example, information presetting module 20 and information obtaining module 40 may together form the first server or the first server cluster, and the list generating module 60 may form a second server or a second server cluster.

In this case, interactions among the above modules may be described as interactions among the first server to a third server, or as interactions between the first server cluster and the second server cluster. The first server to the third server, or the first server cluster and the third server cluster, together may constitute a scheduling system host for container deployment according to the present application.

As shown in FIG. 4, information obtaining module 40 may include a sorting unit 401, a list of ports generating unit 402, and a list of writable directory generating unit 403. Sorting unit 401 may be configured to sort the list of online hosts in accordance with the resources information of the host. Preferably, sorting unit 401 sorts the list of hosts in a descending order of the remaining memory for container. Ports generating unit 402 may be configured to generate the list of ports to be opened by the host according to the obtained configuration information of the port mapping of the container. List of writable directory generating unit 403 may be configured to generate the list of writable directory to be mapped by the host according to the obtained configuration information of the directory mapping of the container. The host whose ports and writable directory have been occupied can be excluded by comparing the obtained list of ports needed to opened and list of the writable directory to be mapped of each host with the ports or writable directory already occupied host to meet the requirements for setting specific port mapping and writable directory mapping and to avoid mapping conflicts of port and writable directory, which may cause failure of startup of the container.

Information obtaining module 40 of the present application may be implemented as a server or server cluster, wherein each unit may be a single server or a server cluster. In this case, interactions among the units are described as interactions among the servers or server clusters to which the units correspond. The multiple servers or server clusters together may form the above information obtaining module 40, to form the host dispatch system for the container deployment of the present application.

In an alternative embodiment, several units in the above-mentioned plurality of units may together form a server or server cluster.

As shown in FIG. 4, preferably, list generating module 60 may include a host processing unit 601 which is configured to delete a host from the list of online hosts or move it to the end of the list of online hosts according to the length of the list of ports to be opened by the host and the list of writable directory to be mapped by the host. The host that has been deployed and is able to support setting the mapping of the container and port and directory of the host is moved to the end of the list of hosts online, which can balance the utilization of host resources in the cluster and avoid the problem that some of the host resources are too idle and some of host resources are overloaded.

Detailed implementation of each module and unit of the system in the embodiment of the present application can be referred to the foregoing method and are not discussed here. At the same time, it should be noted that concerned function modules in the present embodiment of the present application may be implemented by a hardware processor.

FIG. 5 is a diagram showing an architecture for implementing an embodiment of a method for host scheduling and a system for container deployment of the present application. As shown in FIG. 5, the architecture may include a dispatch center 50 and a host cluster, and the host cluster may include any suitable number i of hosts H1-Hi. Dispatch center 50 may perform the scheduling method shown in FIG. 1 to allocate the corresponding host for the container.

In an embodiment of the present application, a non-transitory computer-readable storage medium is provided, which stores executable instructions used to execute any one of methods of the present application as described above.

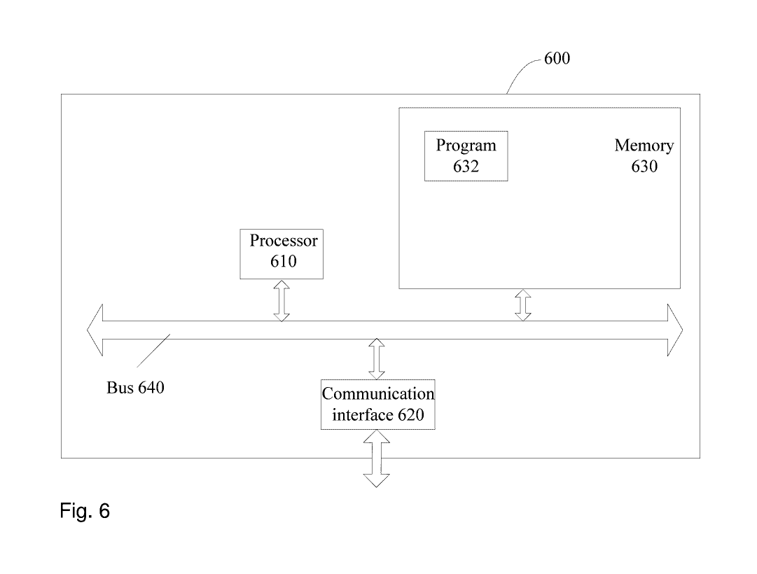

FIG. 6 is a schematic diagram showing a structure of an electronic device for implementing a method for host scheduling for container deployment according to an embodiment of the present application. The embodiment of the present application is not limited to a specific implementation of server 600. As shown in FIG. 6, server 600 may include a processor 610, a communication interface 620, and a memory 630, each being configured to communicate with one other via a communication bus 640.

Communication interface 620 may be configured to communicate with the network elements such as clients.

Processor 610 may be configured to execute program 632, and specifically to execute the related steps in the method of the above embodiment.

Specifically, program 632 may include program codes which include computer operation instructions.

In various embodiments, processor 610 may be implemented, for example, as a central processing unit (CPU) or an Application Specific Integrated Circuit (ASIC), or may be configured to implement one or more integrated circuits according to the present embodiment of the application.

The server in the above-described embodiments may include:

a memory for storing computer operation instructions;

a processor for executing the computer operation instructions stored by the memory, to execute steps of:

obtaining the configuration information of the container to be deployed and the corresponding host cluster;

obtaining a list of online hosts in the host cluster, and

generating a list of deployable hosts according to the configuration information and the resource information of hosts in the list of online hosts. Hosts having insufficient memory, port conflicts, or writable directory conflicts are deleted from the list of online hosts to ensure deploying the container on an appropriate host to meet requirements for setting specific port mapping and writable directory mapping, and to avoid a problem that the container kills the processes due to insufficient memory. Meanwhile, the strategy for deploying container based on the memory is achieved by sorting hosts in the cluster according to the remaining memory for container for container to ensure an equal allocation of memory resources in the host cluster. The potential re-deployable host without port or directory conflicts after allocation is moved to the end of the list to prevent excessive idleness or overload of host resources in the cluster and to ensure a full and balanced utilization of host resources in the cluster.

The above described apparatus embodiments are merely illustrative, and the units described as separating members may or may not be physically separated. Furthermore, the components shown as units may or may not be physical units, i.e. may be positioned in one place, or can be distributed among multiple network elements. Part or all of the modules may be implemented or otherwise utilized to achieve the purpose of the embodiment's solutions according to the actual needs.

Through the above described embodiments, the various embodiments described herein may be implemented by software plus a necessary universal hardware platform, of course, also be implemented by hardware. Based on this understanding, the nature of the technical solutions or the part contributing to the prior art may be embodied in the form of a software product, the computer software product may be stored in a computer readable storage medium, such as ROM/RAM, magnetic discs, CD-ROM, etc., including several instructions to instruct a computer device (may be a personal computer, server, or network equipment) to perform the method of various embodiments or some parts of the embodiment.

Finally, it should be noted that the above embodiments are provided for describing the technical solutions of the present application, but these descriptions are not intended as limitations. Although the present application has been described in detail with reference to the embodiments, those skilled in the art will appreciate the technical solutions described in the foregoing various embodiments can still be modified, or some technical features therein can be equivalently replaced without departing from the spirit and scope of the present application.

What is claimed is:

1. A method of scheduling hosts for container deployment, comprising:
at an electronic device, obtaining configuration information of a container to be deployed and a corresponding host cluster;
obtaining a list of online hosts of the host cluster; and
generating a list of deployable hosts according to the configuration information and resource information of hosts in the list of hosts.

2. The method according to claim 1, further comprising:
sorting the list of online hosts according to the resource information of each host in the list of hosts.

3. The method according to claim 2, wherein:
the configuration information comprises directory mapping information, port mapping information, container memory, and a number of containers to be deployed; and
the resource information of a host in the list of online hosts comprises a remaining memory for the container of the host, a list of ports being occupied, and a list of writable directories being occupied.

4. The method according to claim 3, wherein sorting the list of online hosts according to the resource information of the hosts comprises:
sorting the list of online hosts in a descending order according to the remaining memory for the container of the host.

5. The method according to claim 3, wherein generating the list of deployable hosts according to the configuration information and resource information of hosts in the list of hosts comprises:
generating the list of the writable directories to be mapped by the host according to the directory mapping information;
generating the list of ports to be opened by the host according to the port mapping information; and
obtaining, in sequence, the resource information of each host in the list of online hosts to carry out a matching process, and adding host meeting conditions into the list of deployable hosts until a number of hosts in the list of the deployable hosts equals the number of containers to be deployed.

6. The method according to claim 5, wherein obtaining the resource information of each host in the list of online hosts to carry out a matching process, and adding the host meeting conditions into the list of the deployable hosts comprises:
determining whether the resource information of each host in the list of online hosts meets the following conditions:
the remaining memory for the container is larger than the memory for the container,
there is not a mutual directory contained in the list of the writable directories being occupied and the list of the writable directories to be mapped by the host, and
there is not a same port in the list of ports being occupied and in the list of ports to be opened by the host; and
if each of the conditions are met, adding a host meeting condition into the list of the deployable hosts; and
if each of the conditions are not met, deleting a host not meeting the conditions from the list of online hosts.

7. The method according to claim 6, wherein after adding a host meeting conditions into the list of the deployable hosts, the method further comprises:
determining whether at least one of a length of the list of ports to be opened by the host and a length of the list of writable directories to be mapped by the host is not zero, and
deleting the host meeting conditions from the list of online hosts if at least one of the lengths of the list is not zero, otherwise moving the host meeting conditions to the end of the list of online hosts.

8. A non-transitory computer-readable storage medium storing executable instructions that, when executed by an electronic device, cause the electronic device to:
obtain configuration information of a container to be deployed and a corresponding host cluster;
obtain a list of online hosts of the host cluster; and
generate a list of deployable hosts according to the configuration information and resource information of hosts in the list of online hosts.

9. The non-transitory computer-readable storage medium according to claim 8, further comprising:
executable instructions that, when executed by an electronic device, cause the electronic device to sort the list of online hosts according to the resource information of each host in the list of online hosts.

10. The non-transitory computer-readable storage medium according to claim 9, wherein:
the configuration information comprises directory mapping information, port mapping information, container memory, and a number of containers to be deployed; and
the resource information of a host in the list of online hosts comprises a remaining memory for the container of the host, a list of ports being occupied, and a list of writable directories being occupied.

11. The non-transitory computer-readable storage medium according to claim 10, wherein at the step of sorting the list of online hosts according to the resource information of the hosts, the executable instructions, when executed by an electronic device, further cause the electronic device to
sort the list of online hosts in a descending order according to the remaining memory for the container of the host.

12. The non-transitory computer-readable storage medium according to claim 10,
wherein the executable instructions, when executed by an electronic device, further cause the electronic device to,
generate the list of the writable directories to be mapped by the host according to the directory mapping information;
generate the list of ports to be opened by the host according to the port mapping information; and
obtain, in sequence, the resource information of each host in the list of online hosts to carry out a matching process, and add host meeting conditions into the list of the deployable hosts until a number of hosts in the list of the deployable hosts equals the number of containers to be deployed.

13. The non-transitory computer-readable storage medium according to claim 12, wherein the executable instructions, when executed by an electronic device, cause the electronic device to:
determine whether the resource information of each host in the list of online hosts meets the following conditions:
the remaining memory for the container is larger than the memory for the container,
there is not a mutual directory contained in the list of the writable directories being occupied and the list of the writable directory to be mapped by the host, and
there is not a same port in the list of ports being occupied and in the list of ports to be opened by the host; and
if each of the conditions are met, add a host meeting conditions into the list of the deployable hosts; and
if each of the conditions are not met, delete a host not meeting the conditions from the list of online hosts.

14. The non-transitory computer-readable storage medium according to claim 13, wherein the executable instructions, when executed by an electronic device, further cause the electronic device to:
after adding a host meeting conditions into the list of the deployable hosts, determine whether at least one of a length of the list of ports to be opened by the host and a length of the list of writable directory to be mapped by the host is not zero, and
delete the host meeting conditions from the list of hosts if at least one of the lengths of the list is not zero, otherwise move the host meeting conditions to the end of the list of online hosts.

15. An electronic device, comprising:
at least one processor; and
a memory communicably coupled to the at least one processor configured to store instructions executable by the at least one processor,
wherein execution of the instructions by the at least one processor causes the at least one processor to:
obtain configuration information of a container to be deployed and a corresponding host cluster;
obtain a list of online hosts of the host cluster; and
generate a list of deployable hosts according to the configuration information and resource information of hosts in the list of online hosts.

16. The electronic device according to claim 15, wherein execution of the instructions by the at least one processor causes the at least one processor further to sort the list of online hosts according to the resource information of each host in the list of online hosts.

17. The electronic device according to claim 16, wherein:
the configuration information comprises directory mapping information, port mapping information, container memory, and a number of containers to be deployed; and
the resource information of a host in the list of online hosts comprises a remaining memory for the container of the host, a list of ports being occupied, and a list of writable directories being occupied.

18. The electronic device according to claim 17, wherein execution of the instructions by the at least one processor causes the at least one processor further to:
generate the list of the writable directories to be mapped by the host according to the directory mapping information;
generate the list of ports to be opened by the host according to the port mapping information; and
obtain, in sequence, the resource information of each host in the list of online hosts to carry out a matching process, and add host meeting conditions into the list of the deployable hosts until a number of hosts in the list of the deployable hosts equals to a number of containers to be deployed.

19. The electronic device according to claim 18, wherein execution of the instructions by the at least one processor causes the at least one processor further to:
determine whether the resource information of each host in the list of online hosts meets the following conditions:
the remaining memory for the container is larger than the memory for the container,
there is not a mutual directory contained in the list of the writable directories being occupied and the list of the writable directories to be mapped by the host, and
there is not a same port in the list of ports being occupied and in the list of ports to be opened by the host; and
if each of the conditions are met, add a host meeting conditions into the list of the deployable hosts; and
if each of the conditions are not met, delete a host not meeting the conditions from the list of online hosts.

20. The electronic device according to claim 19, wherein execution of the instructions by the at least one processor causes the at least one processor further to:
after adding a host meeting conditions into the list of the deployable hosts, determine whether at least one of a length of the list of ports to be opened by the host and a length of the list of writable directories to be mapped by the host is not zero, and
delete a host meeting conditions from the list of online hosts if at least one of the lengths is not zero, otherwise move the host meeting conditions to the end of the list of online hosts.
